(19) United States
(12) Patent Application Publication
(10) Pub. No.: US 2025/0316255 A1
(43) Pub. Date: Oct. 9, 2025

(54) VIBRATION-DRIVEN SYNTHESIZER INSTRUMENT

(71) Applicant: Daniel Harry, Oklahoma City, OK (US)

(72) Inventor: Daniel Harry, Oklahoma City, OK (US)

(21) Appl. No.: 19/172,360

(22) Filed: Apr. 7, 2025

Related U.S. Application Data
(60) Provisional application No. 63/575,434, filed on Apr. 5, 2024.
(60) Provisional application No. 63/677,555, filed on Jul. 31, 2024.

(51) Int. Cl. G10H 5/00

(52) U.S. Cl. CPC G10H 5/002

(57) ABSTRACT

The invention relates to systems and processes for producing a synthesized sound with based on vibration-driven analog signals. In one aspect, a synthesized sound is produced with a musical instrument by generating a volume envelope with a voltage generator, generating a wave shape with a pitch modifier, merging the volume envelope from the voltage generator and the wave shape from the pitch modifier to create a synthesized signal, and modifying the synthesized signal using a synthesizer interface. The voltage generator includes an electronic pickup and a magnetic resonance actuator that is positioned above and oriented parallel to the electronic pickup.

### RELATED APPLICATIONS

This application claims the benefit of and priority to U.S. Provisional Patent Application No. 63/575,434 entitled “Spring Vibration Driven Synthesizer-Lute Hybrid with Swappable Spring System” filed Apr. 5, 2024, and U.S. Provisional Patent Application No. 63/677,555 entitled “Spring Vibration Driven Synthesizer-Lute Hybrid with Swappable Spring System” filed Jul. 31, 2024, and incorporates by reference both provisional applications in their entirety.

### FIELD OF THE INVENTION

The invention relates to systems and processes for producing a synthesized sound based on vibration-driven analog signals.

### BACKGROUND OF THE INVENTION

Conventional guitar synthesizers have struggled with several issues including high cost, poor sound quality from error-prone pitch-to-voltage conversions, unappealing midi-based sounds, the need for bulky external equipment, and latency (a delay that hinders a performer's ability to play quickly and accurately).

Furthermore, conventional guitar synthesizers aim to imitate every nuance of the iconic analog sound of a guitar. These efforts tend to result in over-engineering. The resulting instrument serves neither as a functional guitar nor a functional synthesizer.

There remain opportunities to optimize the sound quality and performance of synthesizer instruments and, in particular, synthesizers that are intended to emulate a guitar or other lute instrument. It is to these and other deficiencies in the prior art that the present embodiments are directed.

### SUMMARY OF THE INVENTION

Accordingly, it is an object of this invention to provide systems and processes for producing a synthesized sound with a musical instrument based on vibration-driven analog signals.

In one aspect, a musical instrument includes a voltage generator that is configured to generate a volume envelope, and a synthesizer interface that is configured to modify a synthesized signal that is derived from the volume envelope. The voltage generator includes an electronic pickup and a magnetic resonance actuator positioned above and oriented parallel to the electronic pickup.

In another aspect, a musical instrument includes a voltage generator that is configured to generate a volume envelope, a pitch modifier that is configured to generate a wave shape, and a synthesizer interface that is configured to modify a synthesized signal that is derived from the volume envelope and the wave shape. The voltage generator includes a plurality of electronic pickups and a plurality of magnetic resonance actuators. Each magnetic resonance actuator is positioned above and oriented parallel to one of the electronic pickups.

In yet another aspect, a method is disclosed for producing a synthesized sound with a musical instrument. The method involves steps of generating a volume envelope with a voltage generator, generating a wave shape with a pitch modifier, merging the volume envelope from the voltage generator and the wave shape from the pitch modifier to create a synthesized signal, and modifying the synthesized signal using a synthesizer interface. The voltage generator includes a magnetic resonance actuator that is positioned above and parallel to an electronic pickup.

### BRIEF DESCRIPTION OF DRAWINGS

The above and other objects and advantages of this invention may be more clearly seen when viewed in conjunction with the accompanying drawings wherein:

FIG. 1A is a front view of a musical instrument constructed in accordance with an exemplary embodiment.

FIG. 1B is a side view of the musical instrument of FIG. 1A.

FIG. 2A is a front view of a musical instrument constructed in accordance with another exemplary embodiment.

FIG. 2B is a side view of the musical instrument of FIG. 2A.

FIG. 2C is another side view of the musical instrument of FIG. 2A.

FIG. 3 is a perspective top view of a musical instrument constructed in accordance with another exemplary embodiment.

FIG. 4 is a perspective top view of a musical instrument constructed in accordance with another exemplary embodiment.

FIG. 5 is a perspective top view of a musical instrument constructed in accordance with another exemplary embodiment.

FIG. 6A depicts a magnetic resonance actuator in accordance with an exemplary embodiment and a volume envelope generated by perturbing the same.

FIG. 6B depicts a magnetic resonance actuator in accordance with an exemplary embodiment and a volume envelope generated by perturbing the same.

FIG. 6C depicts a magnetic resonance actuator in accordance with an exemplary embodiment and a volume envelope generated by perturbing the same.

FIG. 6D depicts a magnetic resonance actuator in accordance with an exemplary embodiment and a volume envelope generated by perturbing the same.

FIG. 6E depicts a magnetic resonance actuator in accordance with an exemplary embodiment and a volume envelope generated by perturbing the same.

FIG. 6F depicts a magnetic resonance actuator in accordance with an exemplary embodiment and a volume envelope generated by perturbing the same.

FIG. 6G depicts a magnetic resonance actuator in accordance with an exemplary embodiment and a volume envelope generated by perturbing the same.

FIG. 7 is a top view of a voltage generator in accordance with an exemplary embodiment.

FIG. 8A is a side view of a voltage generator in accordance with an exemplary embodiment, where the magnetic resonance actuator is positioned at the highest possible user-selected height.

FIG. 8B is a side view of the voltage generator of FIG. 8A, where the magnetic resonance actuator is lowered along the actuator mount.

FIG. 8C is a side view of the voltage generator of FIG. 8A, where the magnetic resonance actuator is positioned at the lowest possible user-selected height.

FIG. 9A is another side view of the voltage generator of FIG. 8A.

FIG. 9B is another side view of the voltage generator of FIG. 8B.

FIG. 9C is another side view of the voltage generator of FIG. 8C.

FIG. 10A is a perspective top view of a voltage generator constructed in accordance with an exemplary embodiment, wherein a magnetic resonance actuator is held above an electronic pickup by an actuator mount.

FIG. 10B is a perspective top view of the voltage generator of FIG. 10A, wherein the magnetic resonance actuator is unlocked from the actuator mount.

FIG. 10C is a perspective top view of the voltage generator of FIG. 10A, wherein the magnetic resonance actuator is removed from the actuator mount.

FIG. 10D is a perspective top view of the voltage generator of FIG. 10A, wherein a second magnetic resonance actuator is inserted into the actuator mount.

FIG. 10E is a perspective top view of the voltage generator of FIG. 10A, wherein the second magnetic resonance actuator is locked within the actuator mount.

FIG. 11A is a side view of a voltage generator in accordance with an exemplary embodiment, where a magnetic resonance actuator is perturbed by a user's fingers.

FIG. 11B is a side view of the voltage generator of FIG. 11A, where the magnetic resonance actuator is removed from the actuator mount.

FIG. 11C is a side view of the voltage generator of FIG. 11B, where a second magnetic resonance actuator is inserted into the actuator mount.

FIG. 11D is a side view of the voltage generator of FIG. 11C, where the second magnetic resonance actuator is perturbed with either a guitar pick or a violin bow.

FIG. 12A depicts a representation of an interaction between a north pole of a handheld magnetic resonance actuator and an electronic pickup in accordance with an exemplary embodiment.

FIG. 12B depicts a representation of another interaction between the north pole of the handheld magnetic resonance actuator in FIG. 12A and the electronic pickup.

FIG. 12C depicts a representation of an interaction between a south pole of the handheld magnetic resonance actuator in FIG. 12A and the electronic pickup.

FIG. 12D depicts a representation of another interaction between the south pole of the handheld magnetic resonance actuator in FIG. 12A and the electronic pickup.

FIG. 13 depicts a pitch modifier in accordance with an exemplary embodiment.

FIG. 14 depicts a synthesizer interface for the musical instrument of FIG. 2A.

FIG. 15 depicts a synthesizer interface for the musical instrument of FIG. 1A.

FIG. 16 depicts a synthesizer interface in accordance with another exemplary embodiment.

FIG. 17 is a flowchart depicting a method for generating sound with a musical instrument in accordance with an exemplary embodiment.

FIG. 18A is a diagram for generating a volume envelope in accordance with an exemplary embodiment.

FIG. 18B is a diagram for generating a wave shape in accordance with an exemplary embodiment.

FIG. 18C is a diagram for merging the volume envelope of FIG. 18A with the wave shape of FIG. 18B in accordance with an exemplary embodiment.

FIG. 19 is a diagram for mixing a plurality of synthesized signals (i.e., inputs) to produce a synthesized sound in accordance with an exemplary embodiment.

FIG. 20 is a diagram for mixing a plurality of synthesized signals in accordance with another exemplary embodiment.

### DETAILED DESCRIPTION

While this invention is susceptible to embodiment in many different forms, there are shown in the drawings and will be described hereinafter in detail some specific embodiments of the invention. It should be understood, however, that the present disclosure is to be considered an exemplification of the principles of the invention and is not intended to limit the invention to the specific embodiments so described.

The systems and methods disclosed herein offer creative avenues for musical expression. It has been discovered that a musical instrument can be configured to combine analog physical inputs from two points of contact, which facilitate tactile feedback and expressiveness, with the sound generation capabilities of an analog synthesizer. The combination of mechanical and electronic elements also provides a unique sound that is not similarly generated by traditional string-based or purely electronic musical instruments. Due to the robust, instantaneous nature of the electrical pulses used by the musical instrument, its configuration offers rapid response times with a minimal number of components.

Referring now to the figures of the drawings, wherein like numerals of reference designate like elements throughout the several views, a musical instrument 100 is disclosed as having a body 102, a voltage generator 104, a pitch modifier 106, and a synthesizer interface 108. In general, the musical instrument 100 uses analog physical input components from two points of user interaction: at the voltage generator 104 (where one hand causes a vibration that initiates a volume envelope for a tone emitted by the musical instrument 100) and at the pitch modifier 106 (where the other hand sets a frequency or pitch for the sound output by the musical instrument 100). As used herein, the terms “envelope” and “volume envelope” are understood to refer to the trail of change in volume over time for a musical note, and the term “analog” is understood to refer to information that is translated into electrical pulses of varying amplitude without use of a computer (compared to “digital” information, which is translated into binary format to represent distinct amplitudes). In various embodiments, the disclosed musical instrument 100 does not use any digital processing. It will be appreciated, however, that the musical instrument 100 uses one or more digital signals in other embodiments.

The body 102 of musical instrument 100 may be shaped and scaled to emulate different traditional instruments, including instruments with fretted or fretless necks, commonly known as lutes. Traditional lute instruments (e.g., guitars, banjos, Japanese shamisens, violins) have strings that may be plucked, bowed, struck, or otherwise perturbed to produce sound. While one hand perturbs a string, the other hand varies the length of the vibrating string by pressing the string into the neck.

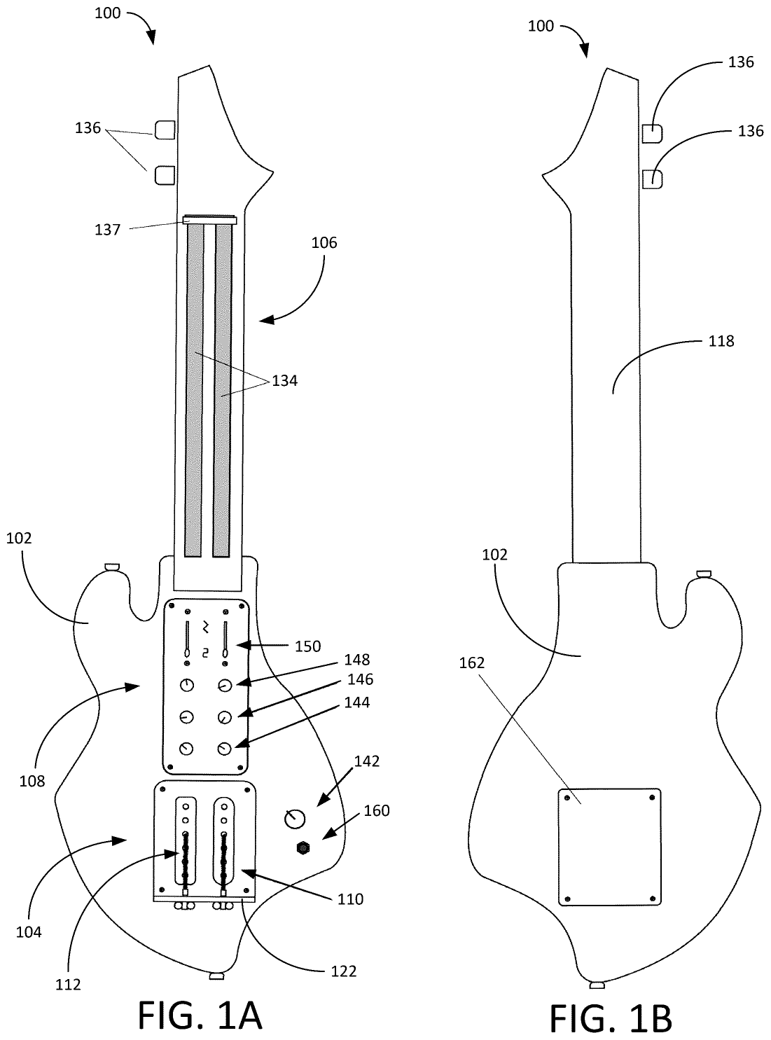

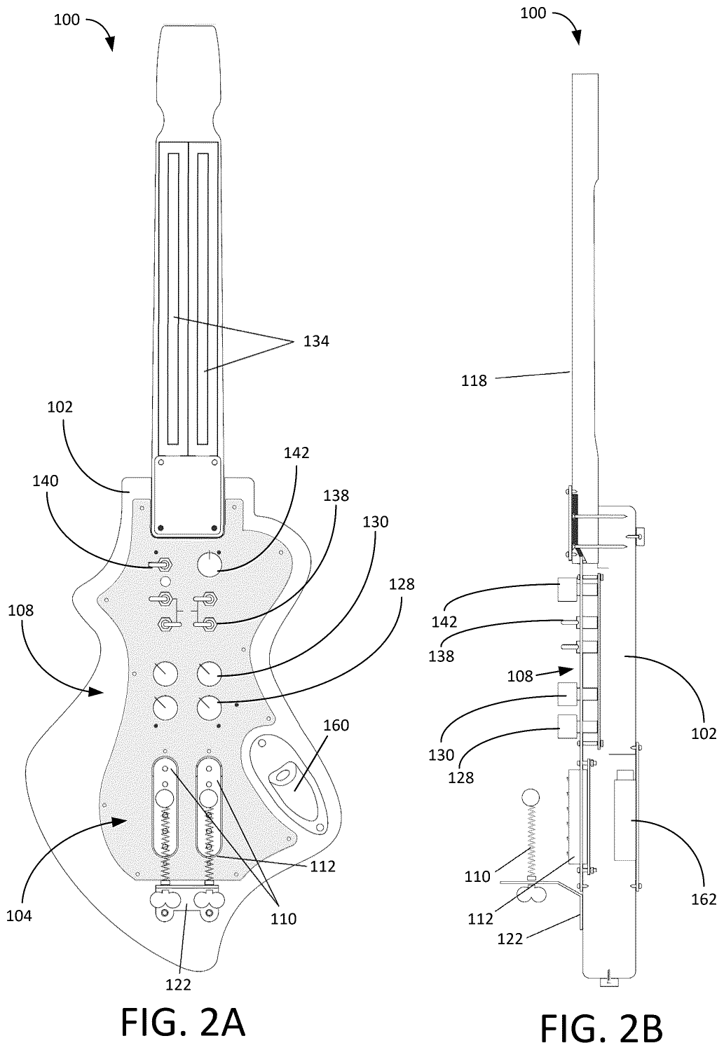

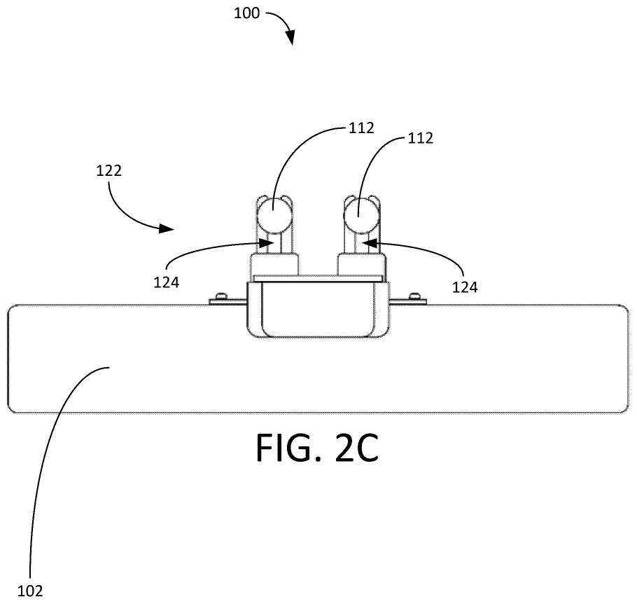

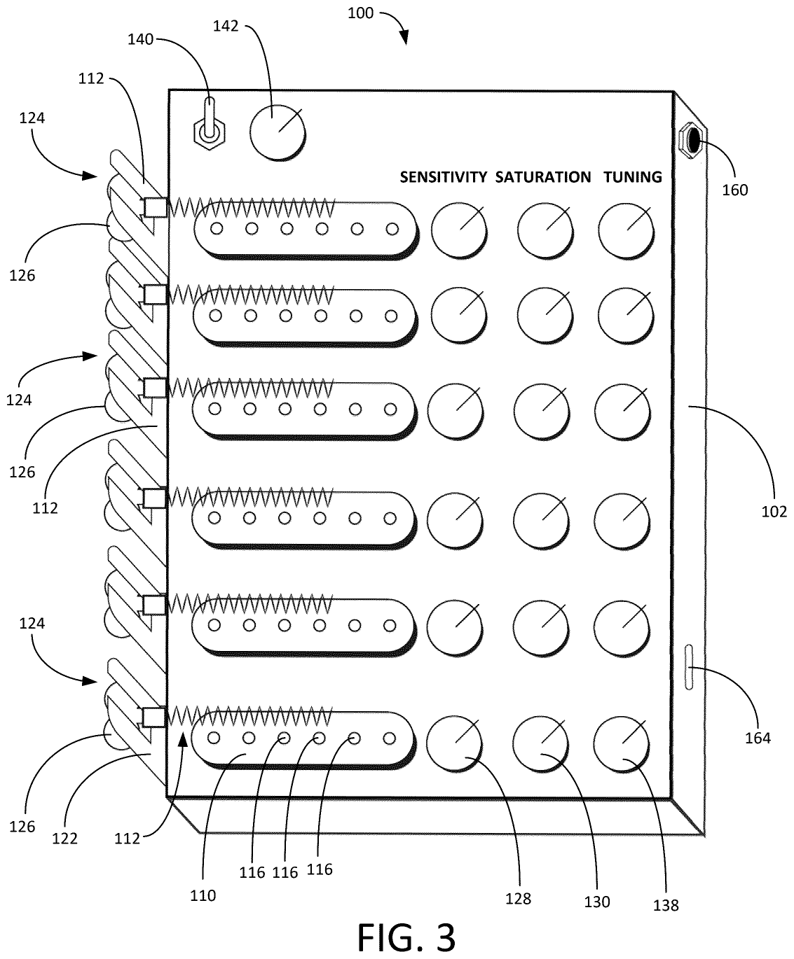

As depicted in FIGS. 1-2, the body 102 may have a shape that resembles an electric guitar. In other embodiments, the body 102 is configured to rest on the user's lap or a flat surface during play. The musical instruments 100 depicted in FIGS. 3-5, for example, are configured to be played while the body 102 is resting on a table-top surface. Suitable materials for the instrument body 102 include wood, resin, metal, plastic, and carbon fiber. In various embodiments, the body 102 has a body length ranging from about 21 inches to about 42 inches (i.e., larger than a ukulele but smaller than an acoustic guitar).

The voltage generator 104 is configured to produce an analog electronic signal. More particularly, the voltage generator 104 utilizes a combination of one or more electronic pickups 110 and one or more magnetic resonance actuators 112 that interact with the electronic pickup(s) 110 to produce vibration-driven voltage. The terms “pickup” and “electronic pickup,” as used herein, refer to devices for converting mechanical vibrations of the magnetic resonance actuators 112 into electrical impulses that can be used for the production of sound. In various embodiments, the electronic pickup 110 is a magnetic pickup, such as a single coil pickup, a humbucker, or a split coil pickup. The electronic pickup 110 creates a magnetic field 114 that is focused by a plurality of magnetic pole pieces 116. Each electronic pickup 110 is attached to the body 102 of the musical instrument 100. In some embodiments, the electronic pickups 110 can be longitudinally aligned with the magnetic resonance actuators 112, as depicted in FIG. 1A. In other embodiments, the electronic pickups 110 are oriented in a transverse or angularly offset relationship with the magnetic resonance actuators 112. Where the body 102 is shaped to resemble a guitar, the electronic pickups 110 may be positioned in longitudinal alignment with a neck 118 of the guitar (see FIGS. 1-2).

To produce a vibration-driven analog signal, each electronic pickup 110 interacts with one or more of the magnetic resonance actuators 112. The magnetic resonance actuators 112 are generally constructed from a metal or metal alloy. Suitable materials for the magnetic resonance actuator 112 include, without limitation, stainless steel, phosphor bronze, and spring steel (e.g., low-alloy manganese, medium-carbon steel, or high-carbon steel). In various embodiments, the magnetic resonance actuator 112 is ferromagnetic. When the magnetic resonance actuator 112 vibrates or otherwise moves near the electronic pickup 110, the magnetic field 114 around the electronic pickup 110 moves with the magnetic resonance actuator 112 (e.g., vibrates up and down). This movement of the magnetic field 114 induces a voltage in the electronic pickup 110.

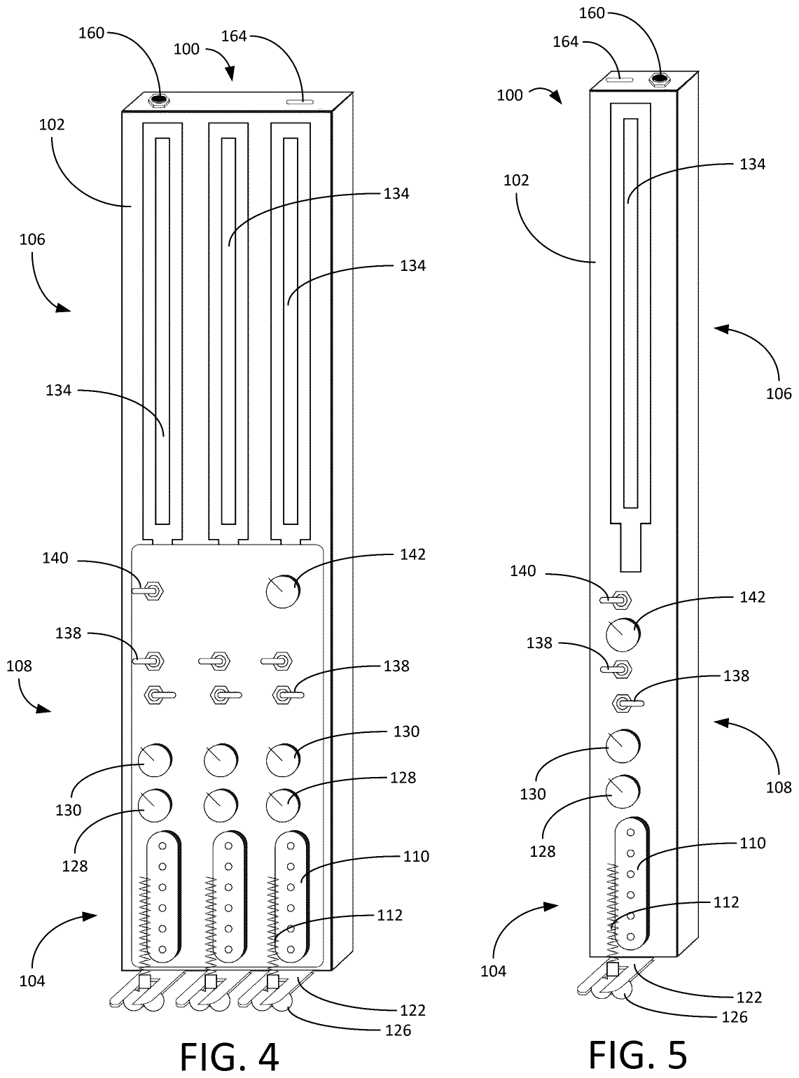

In some embodiments, the musical instrument 100 includes only one magnetic resonance actuator 112, whereas in other embodiments, the instrument includes 2, 3, 4, 5, 6, 7, 8, 9, 10, 11, or 12 magnetic resonance actuators 112. FIGS. 1-2 depict embodiments in which two magnetic resonance actuators 112 are attached to the body 102 of the musical instrument 100. FIG. 3 depicts an embodiment in which six magnetic resonance actuators 112 are instead attached to the body 102, and FIGS. 4 and 5 depict, respectively, the use of three magnetic resonance actuators 112 and one magnetic resonance actuator 112 attached to the body 102. It will be appreciated that the number of magnetic resonance actuators 112 used for the musical instrument 100 may vary based on the type of magnetic resonance actuator(s) 112 used or to facilitate different play styles. For example, where the musical instrument 100 is intended to be played like a standard guitar, six magnetic resonance actuators 112 may be used to mimic a guitar's six-stringed configuration. In various non-limiting embodiments, depending on the player's choice of magnetic resonance actuator 112, the musical instrument 100 can be picked like a guitar, fingered or slapped like a bass, or bowed like a violin.

Each magnetic resonance actuator 112 may be either a mounted magnetic resonance actuator or a handheld magnetic resonance actuator. When the magnetic resonance actuator 112 is a mounted magnetic resonance actuator, the magnetic resonance actuator 112 is attached (permanently or removably) to the body 102. On the other hand, when the magnetic resonance actuator 112 is a handheld magnetic resonance actuator, it is not attached to the body 102 and is, instead, held by one of the user's hands when the instrument is played.

As depicted in FIGS. 1-5, the magnetic resonance actuators 112 are mounted magnetic resonance actuators, each positioned above a corresponding electronic pickup 110. Each mounted magnetic resonance actuator 112 is mounted within the magnetic field 114 of the electronic pickup 110 directly below. Unlike a standard guitar, where multiple strings are oriented perpendicular or diagonal to a guitar pickup, each mounted magnetic resonance actuator 112 is oriented parallel to one corresponding electronic pickup 110 and extends over multiple magnetic pole pieces 116 of the electronic pickup 110.

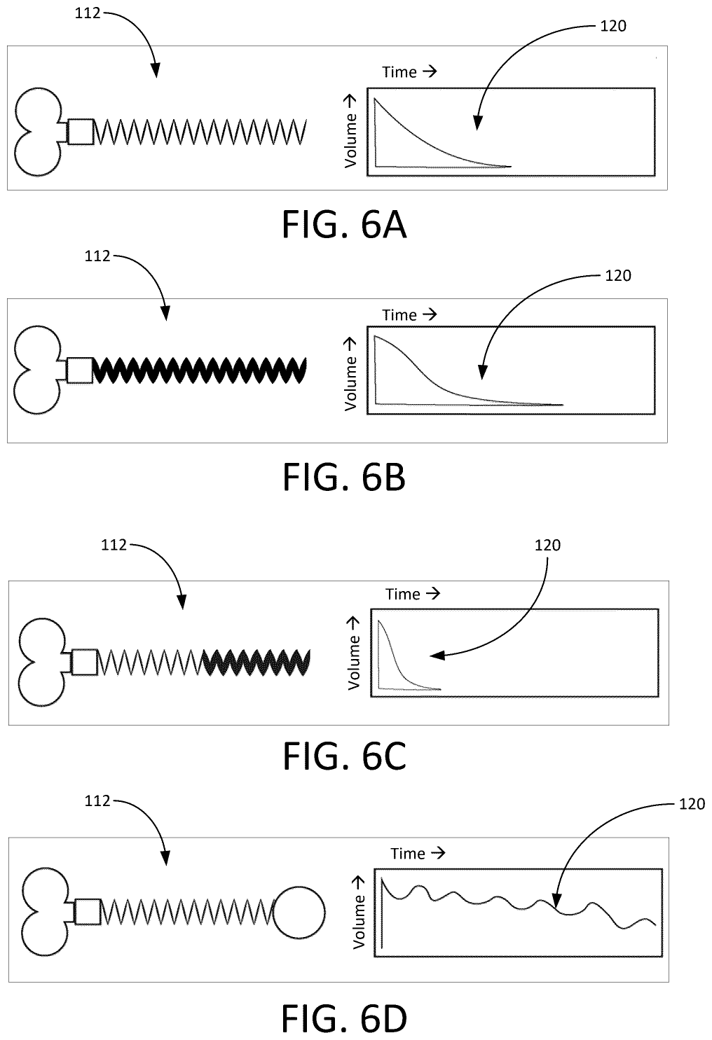

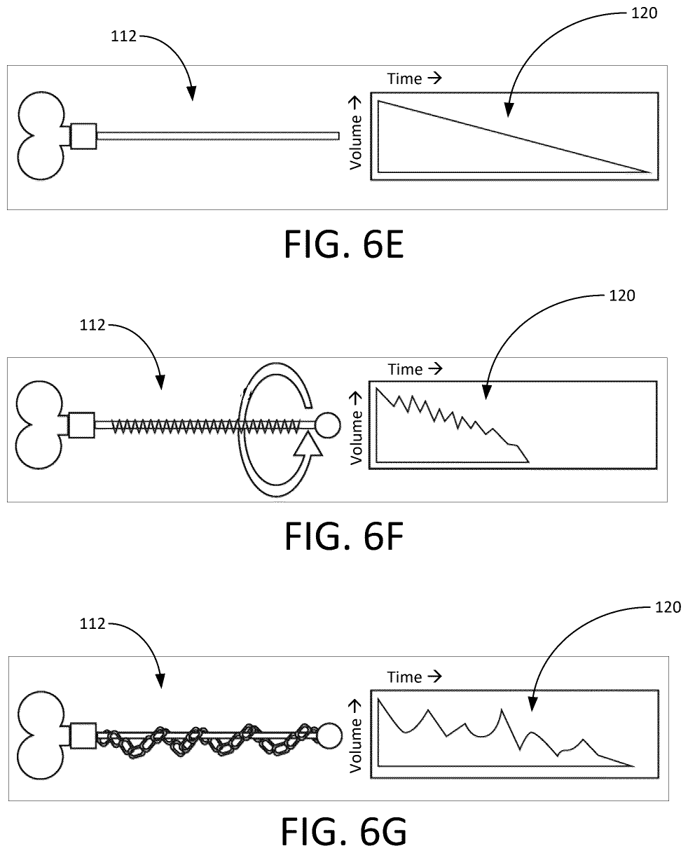

Different types of mounted magnetic resonance actuators 112 can also be used to produce distinct sounds from the musical instrument 100. Suitable mounted magnetic resonance actuators 112 include rods, springs, other flexibly vibrating elements, and combinations of the same. Different volume envelopes 120 may be generated based on the thickness and/or tension of the mounted magnetic resonance actuator 112. Comparing FIGS. 6A and 6B, where FIG. 6A depicts a standard spring and FIG. 6B depicts a heavy spring, the volume envelope 120 for the heavy spring has a longer duration than the volume envelope 120 for the standard spring. As used herein, the term “heavy spring” refers to a heavy-duty spring having a wire diameter ranging from ¼″ to 1″ in thickness.

As depicted in FIG. 6C, a mute-type mounted magnetic resonance actuator 112 is used to make short marimba-type notes. The mute-type mounted magnetic resonance actuator 112 is a ferromagnetic spring or rod that is fully or partially dipped in silicone or another vibration-dampening material. The resulting volume envelope 120 has a short duration compared to other mounted magnetic resonance actuators 112.

Another exemplary mounted magnetic resonance actuator 112 is a tremolo-type mounted magnetic resonance actuator 112, depicted in FIG. 6D, which is a ferromagnetic spring or rod that is affixed at one end to a heavy ferromagnetic weight, such as a half-inch steel bearing. Unlike the mute-type mounted magnetic resonance actuator 112, the tremolo-type mounted magnetic resonance actuator 112 has an exceptionally slow decay due to the weight at its end and, therefore, the oscillation of the magnetic resonance actuator 112 over the electronic pickup 110 produces a tremolo-like response that lasts longer than other types of mounted magnetic resonance actuators 112. The depicted volume envelope 120 demonstrates this slow tremolo-like decay.

Turning to FIG. 6E, a sustain-type mounted magnetic resonance actuator 112 is a naked ferromagnetic rod that is designed to product a naturalistic, long sustained note with a pleasing natural fade, which is reflected in a steady slope of the resulting volume envelope 120. The sustain-type mounted magnetic resonance actuator 112 can be played with a guitar pick or, with the addition of violin rosin, a violin bow.

Another type of mounted magnetic resonance actuator 112 is the nonlinear mounted magnetic resonance actuator 112, which combines ferromagnetic springs or rods with different masses, tensions, and/or configurations which, together, vibrate in an unpredictable and interesting manner. An exemplary nonlinear mounted magnetic resonance actuator 112 is a heavy spring attached to an off-center light spring.

Other mounted magnetic resonance actuators 112 may combine a central ferromagnetic rod with another element to produce a special sound effect. For example, the spinner-type mounted magnetic resonance actuator 112 depicted in FIG. 6F uses a central rod that runs through a free-spinning spring or other free-spinning ferromagnetic form, with a stopper at the end of the rod to keep the spinning element in place. Before the spinner-type mounted magnetic resonance actuator 112 is perturbed, it stops itself in a downward position, being drawn to the magnet in the electronic pickup 110. When the spinner-type mounted magnetic resonance actuator 112 is perturbed or plucked, the spinning element spins around the central rod until it loses momentum from being attracted to the magnet. The resulting volume envelope 120 reflects rapidly occurring and sharp changes in direction.

In other embodiments, the mounted magnetic resonance actuator 112 is a chain-type mounted magnetic resonance actuator 112 as depicted in FIG. 6G. The chain-type mounted magnetic resonance actuator 112 includes a central rod with a small-diameter ferromagnetic chain attached or wrapped around it. This rod-and-chain combination generates a jingle-jangle tone and a volume envelope 120 with sharp changes in direction.

It will be appreciated that different types of mounted magnetic resonance actuators 112 can be used in combination on the body 102 of the musical instrument 100 to generate unique vibration patterns. For example, in one non-limiting embodiment, a tremolo-type mounted magnetic resonance actuator 112 is mounted over one electronic pickup 110 of the musical instrument 100, and a mute-type mounted tone actuator is simultaneously mounted over another electronic pickup 110. Other non-limiting embodiments include combinations of rod-based mounted magnetic resonance actuators 112 and spring-based mounted magnetic resonance actuators 112.

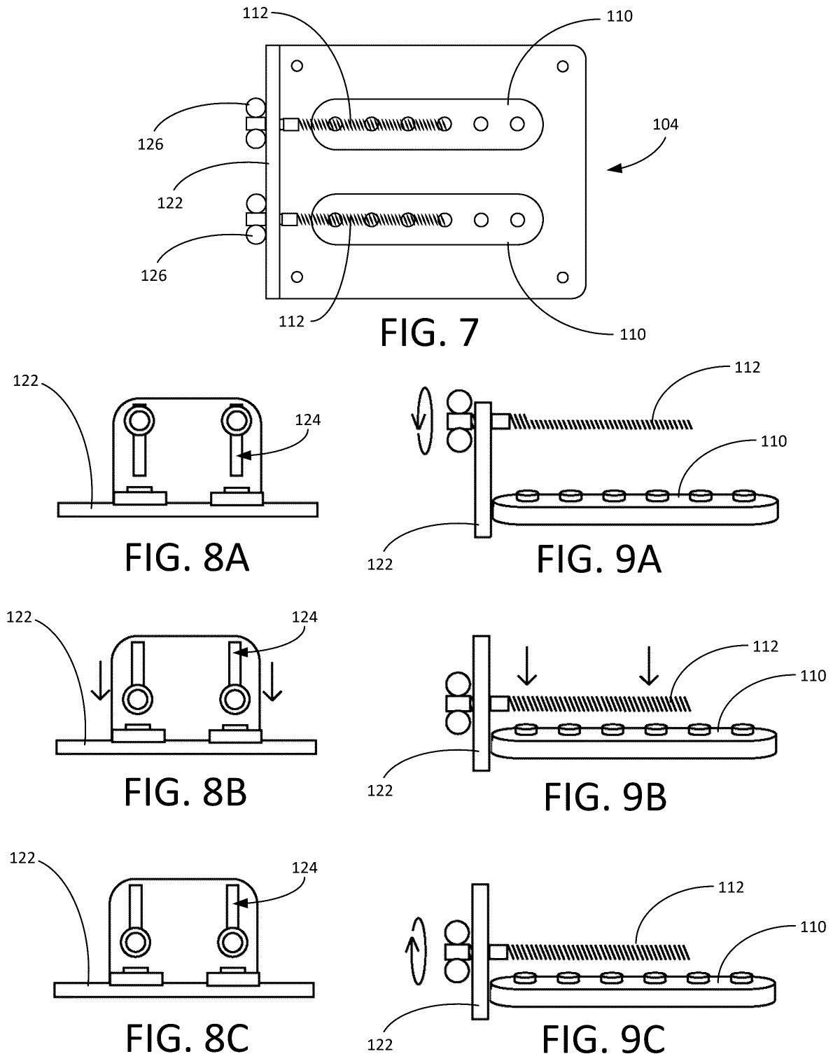

The voltage generator 104 may also include one or more actuator mounts 122 that hold the magnetic resonance actuators 112 at user-selected heights above their corresponding electronic pickups 110. Unlike conventional guitar strings that are held in place on opposite sides of the instrument with tuning controls for adjusting the tension on the musical string, many of the resonance actuators 112 disclosed herein are secured by a single “proximal” end by an actuator mount 122, such that an opposite “distal” end of the resonance actuator 112 is suspended over the electronic pickup 110. FIGS. 1A depicts a single actuator mount 122 that is configured to hold all the mounted magnetic resonance actuators 112 that are attached to the musical instrument 100, whereas FIG. 2A-2C depict an embodiment of the voltage generator 104 where each magnetic resonance actuator 112 has a designated actuator mount 122. Turning to FIGS. 7-8 a single actuator mount 122 is depicted as holding two mounted magnetic resonance actuators 112. The actuator mount 122 includes a channel 124 for each magnetic resonance actuator 112, which allows the magnetic resonance actuator 112 to be moved toward and away from its corresponding electronic pickup 110. The depicted channels 124 are routed out of a metal plate that protrudes from the body 102 at a perpendicular orientation. Once the user has selected a suitable height for the magnetic resonance actuator 112 in relation to its corresponding electronic pickup 110, the distance between the magnetic resonance actuator 112 and the electronic pickup 110 may be set manually using one or more locks 126. Each lock 126 for the actuator mount 122 may be a finger-operated locking mechanism. In various embodiments, the lock 126 uses thumbscrews, wingnuts, clamps, or combinations of the same to secure the respective magnetic resonance actuator 112 at the user-selected height within its channel 124. As shown in FIGS. 9A-9C, the height of the magnetic resonance actuator 112 may be subsequently adjusted by unlocking the lock 126 (FIG. 9A), moving the magnetic resonance actuator 112 to a different position along the channel 124 (FIG. 9B), and relocking the lock 126 (FIG. 9C).

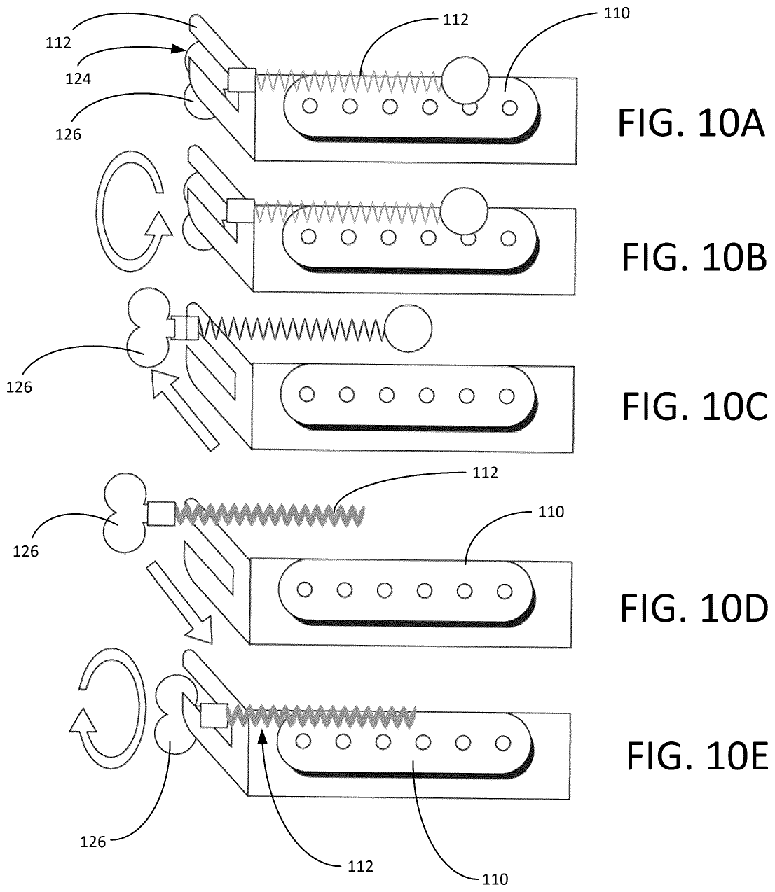

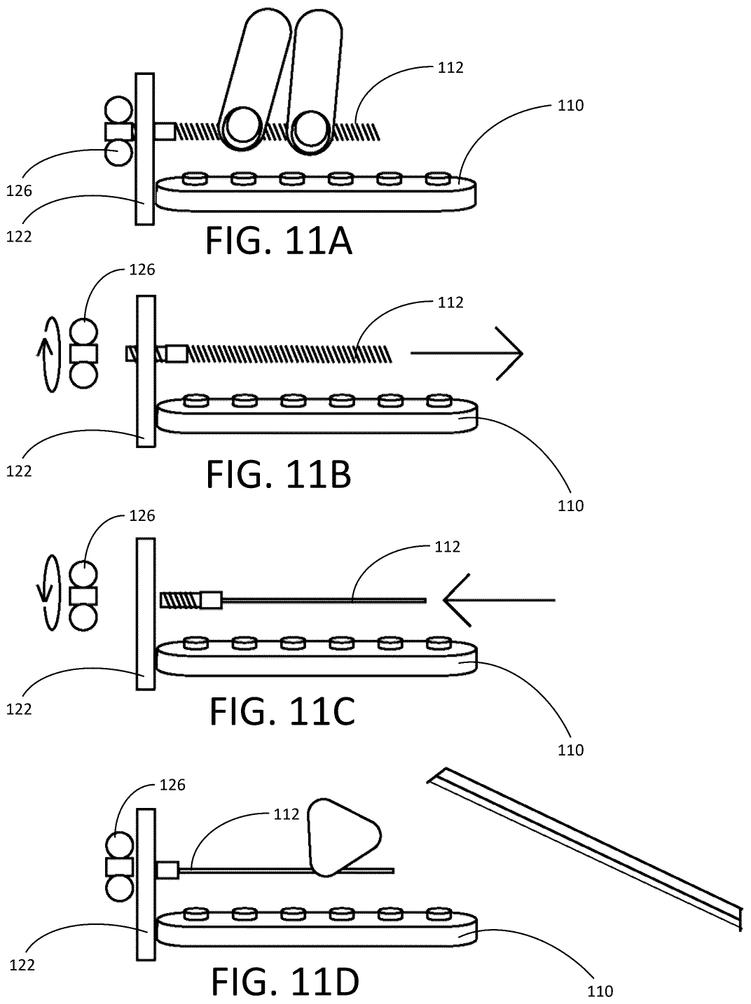

FIGS. 10 and 11 depict exemplary embodiments in which one magnetic resonance actuator 112 is removed from its designated actuator mount 122 and is swapped out for a magnetic resonance actuator 112 that produces different sound characteristics. For example, the tremolo-type magnetic resonance actuator 112 depicted in FIG. 10A is unlocked at FIG. 10B and removed from the actuator mount 122 at FIG. 10C. In FIGS. 10D-10E, respectively, a heavy spring is inserted into the channel 124 of the actuator mount 122 and locked into place using the lock 126. This interchangeability of the magnetic resonance actuators 112 provides a high degree of versatility and personalization. By changing the magnetic resonance actuator 112 that is mounted within an actuator mount 122, the musical instrument 100 may be adapted to a wide range of musical genres and styles. FIG. 11 depicts an embodiment in which a spring is initially perturbed by the user's fingers to generate vibrations (FIG. 11A) and is then unlocked and removed from the actuator mount 122 (FIG. 11B). To facilitate a different mode of play, a metal rod is inserted and locked into the same actuator mount 122 (FIG. 11C). This metal rod may then be perturbed using a guitar pick or a violin bow to create the desired volume envelope 120.

Turning to the handheld magnetic resonance actuators 112, these magnetic resonance actuators 112 interact with magnetic fields 114 from one or more electronic pickups 110 but are not physically attached to the body 102 of the musical instrument 100. For example, a handle-based handheld magnetic resonance actuator 112 uses a handle made from a vibration-resistant material (e.g., wood or plastic). Hardware is included on the handle, where the hardware engages and locks one or more rods, springs, and/or other flexibly vibrating elements (including those described above for the different types of mounted magnetic resonance actuators 112 shown in FIGS. 6A-6G) onto the handle. The handle's resistance to vibration maximizes the vibrational resonance of the flexibly vibrating elements. In various embodiments, the user holds the handle-based handheld magnetic resonance actuator 112 in one hand and plucks, thumps, or otherwise perturbs the flexibly vibrating element with the other hand. Once perturbed, the vibrating handheld magnetic resonance actuator 112 is positioned near the electronic pickup 110 that the user wishes to “play” to vibrate its magnetic field 114.

Other suitable handheld magnetic resonance actuators 112 include a plectrum actuator. For example, the plectrum actuator may be a standard guitar pick containing a flat neodymium magnet, which is used to “pick” the air above or around an electronic pickup 110. In another embodiment, the plectrum actuator is a set of finger picks, each mounted to an individual finger, which allows the user to “play” the electronic pickups 110 akin to a banjo play style. These configurations allow the user to interact with the magnetic field 114 above the electronic pickup 110 to produce sounds without physically contacting the pickup 110. In some embodiments, a mounted magnetic resonance actuator 112 is first removed from its actuator mount 122 on the body 102 of the musical instrument 100 to allow its corresponding electronic pickup 110 to be “played” by the plectrum actuator in the space above the electronic pickup 110.

The proper distance to pick the air above the electronic pickup 110 with the plectrum actuator may be fine-tuned using sensitivity adjustment knobs 128 and/or signal saturation knobs 130. In various embodiments, the distance between the plectrum actuator and the electronic pickup 110 ranges from about 5 cm to about 1 mm, more particularly from about 4 cm to about 5 mm, more particularly from about 3 cm to about 1 mm, more particularly about 2 mm.

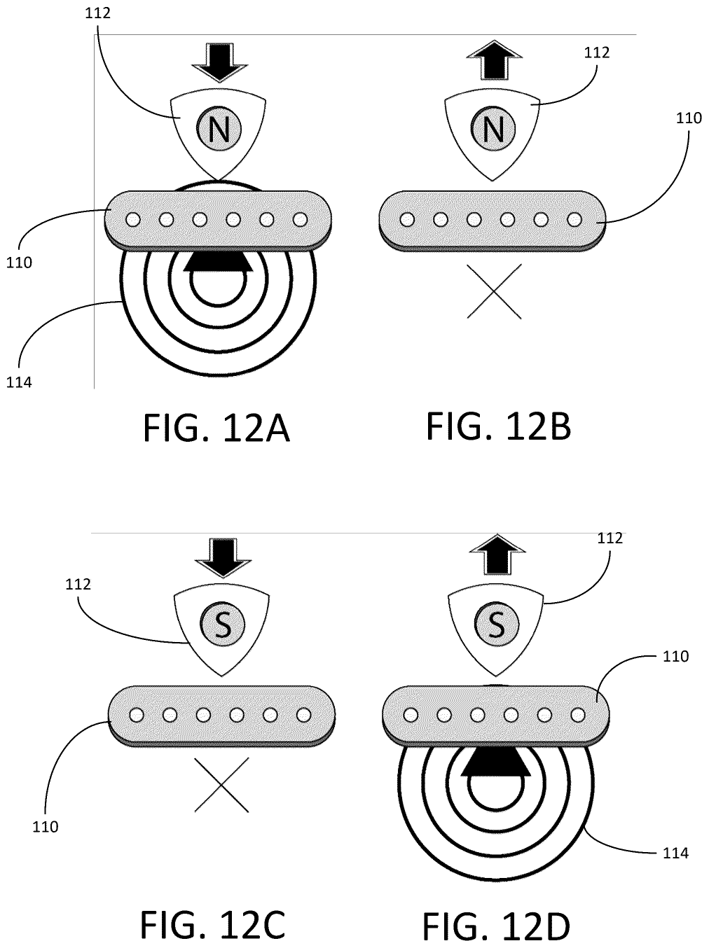

It will be appreciated that the direction a plectrum actuator is moved may influence its sound production. According to various embodiments, the negative signal of each electronic pickup 110 is sent to ground and discarded; therefore, one pole of the plectrum actuator will only produce sound while approaching the pickup 110, while the other pole will only produce sound while moving away from the pickup 110. FIGS. 12A and 12B depict an embodiment in which the north pole of the plectrum actuator generates sound when moved in one direction perpendicular to the electronic pickup 110 but not when moved in the opposite direction. The south pole of the plectrum actuator, on the other hand, does not generate sound when moved in the direction that produces sound from the north pole (compare FIG. 12C to FIG. 12A) but creates sound when moved perpendicular to the electronic pickup 110 in the opposite direction (compare FIG. 12D to FIG. 12B). This dynamic sound generation introduces an additional realm of creative expression with the musical instrument 100.

In some embodiments, the musical instrument 100 also includes a dedicated circuit board that processes impulses created by perturbation of the magnetic resonance actuator(s) 112. The circuit board removes high frequency oscillations to produce a smooth deteriorating volume envelope, which is then routed to an operational amplifier 132 (e.g., a voltage-controlled amplifier (VCA) such as an LM358 Op Amp IC) for further processing. The amplifier 132 may use that signal to modulate a carrier wave.

Turning to the pitch modifier 106, this component of the musical instrument 100 produces an analog signal that controls the frequency that defines the pitch for the sound produced by the musical instrument 100. As depicted in FIGS. 1-2, where the voltage generator 104 is positioned at the lower end of a guitar-shaped body 102, and the pitch modifier 106 is located along the neck 118 of the body 102.

In various embodiments, the pitch modifier 106 includes one or more membrane potentiometers 134, which may be soft membrane linear pressure-sensitive potentiometers (i.e., softpots), and the tone or pitch of the musical instrument 100 is adjusted as a function of the resistance applied by the pitch modifier 106 to a baseline electrical signal. Each membrane potentiometer 134 includes a top circuit, circuit spacer, and bottom circuit.

Different positions of the user's finger along the membrane potentiometers 134 effect different resistance as the top and bottom circuits are placed into contact. Although FIGS. 1 and 2 both depict the pitch modifier 106 as having two membrane potentiometers 134, it will be appreciated that in other embodiments, a suitable number of membrane potentiometers 134 includes 1, 3, 4, 5, 6, 7, and 8 membrane potentiometers 134. FIGS. 4A and 4B, for example, respectively depict pitch modifiers 106 having three membrane potentiometers 134 and one membrane potentiometer 134. Each of the separate membrane potentiometers 134 can simultaneously produce distinct sounds and pitches. That is, a pitch modifier 106 with multiple potentiometers 134 can simultaneously produce multiple sounds.

Fingering a membrane potentiometer 134 triggers one of a plurality of oscillators (not shown) for the pitch modifier 106 and thereby produces a raw, unfiltered waveform (the “wave shape”). The wave shape generated by the oscillators may have any fundamental shape, including a square, ramp, triangle sine, saw, or noise wave. No tone is emitted from the oscillators until a membrane potentiometer 134 is touched, and frequency/pitch are varied based on the user's interaction with the membrane potentiometer 134. In embodiments of the musical instrument 100 that resemble a lute, the oscillator may be activated when the user contacts (“frets”) the associated membrane potentiometer 134 and silenced when the user's finger is removed from the membrane potentiometer 134. In a noise circuit, the membrane potentiometer 134 from the pitch modifier 106 may also act as a sweeping filter for sound effects.

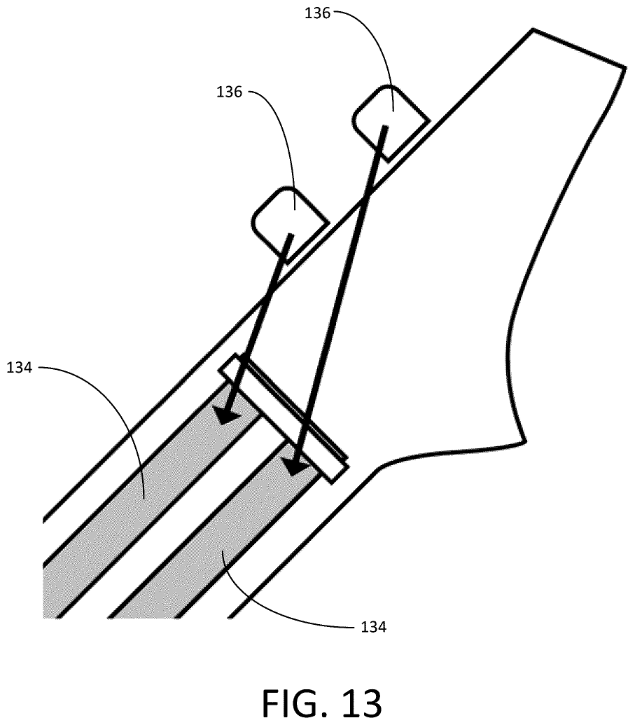

Tuning potentiometers 136 may be used to vary the wave shape produced by the membrane potentiometers 134. In the embodiments shown in FIGS. 1 and 2, the tuning potentiometers 136 are placed on a headstock of the body 102, and the number of tuning potentiometers 136 matches the number of magnetic resonance actuators 112 and electronic pickups 110, thus enhancing the usability and guitar-like feel of the musical instrument 100. As depicted in FIG. 13, each tuning potentiometer 136 is associated with a corresponding membrane potentiometer 134.

The pitch modifier 106 also optionally includes a neck-mounted “nut” mechanism 137, such as a clamp or a band, that places pressure at the lowest portion of each membrane potentiometer 134, similar to a capo for a guitar neck. The nut mechanism 137 may be adjusted during play for a key transposition effect. The user can release this nut mechanism 137, allowing for more dynamic solo play and quieter operation, or the user can engage this mechanism 137, which allows for a more natural “open string” play style that is familiar to string players. The nut mechanism 137 may also target a single membrane potentiometer 134, allowing for dynamic key transposition in association with a single magnetic resonance actuator 112.

In various embodiment, the pitch modifier 106 also includes octave transposition switches to vary the pitch up or down by an octave.

Where the musical instrument 100 mimics a harp-type instrument, rather than a guitar, the pitch modifier 106 may use one or more tuning knobs or switches 138 in place of the membrane potentiometers 134. As shown in FIG. 3, the pitch modifier 106 includes a plurality of tuning knobs 138 to set the pitch to a specific note, emulating a harp string. Each tuning knob 138 may be designated to tune the frequency for the tone generated by a corresponding magnetic resonance actuator 112 and its corresponding electronic pickup 110. Thus, in embodiments where the musical instrument 100 resembles a harp, the oscillator can be constantly activated, with the output volume corresponding to the vibrational intensity of the magnetic resonance actuator 112 associated with the oscillator.

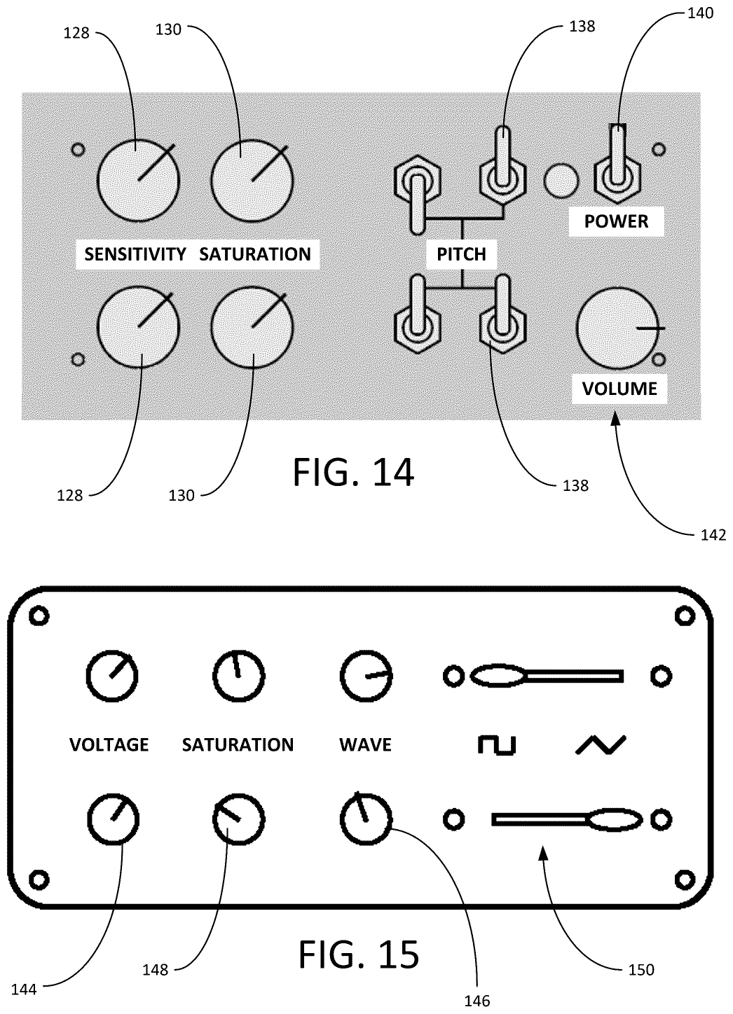

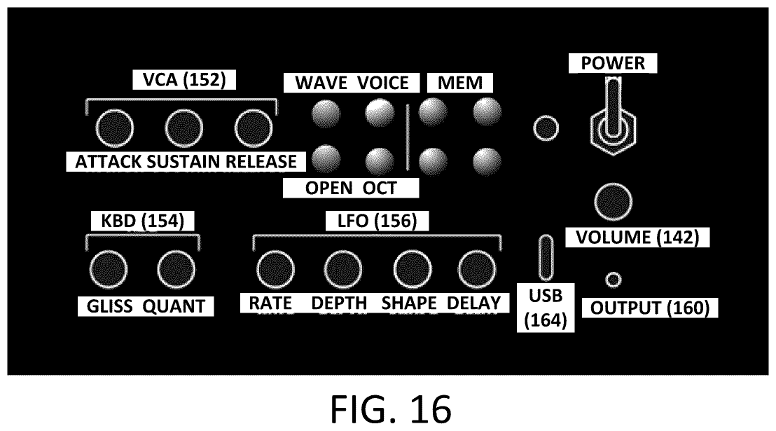

The synthesizer interface 108 of the musical instrument 100 is configured to process the analog signals produced by the voltage generator 104 and the pitch modifier 106. FIGS. 14 and 15 depict embodiments of the synthesizer interface 108 that are configured to modify analog signals, whereas FIG. 16 depicts an embodiment where the synthesizer interface 108 is configured to modify digital signals. FIG. 14 depicts an embodiment in which the sensitivity adjustment knobs 128, signal saturation knobs 130, and tuning switches 138 are incorporated into the synthesizer interface 108, alongside a power switch 140 and a volume knob 142. As shown in the embodiment of FIG. 15, the synthesizer interface 108 includes three potentiometers per magnetic resonance actuator 112, which are (i) a potentiometer that controls the envelope input signal from the voltage generator (see 144), (ii) a potentiometer that controls the wave input volume (see 146), and (iii) a potentiometer that controls the saturation or sustain of the synthesized signal (see 148). The saturation potentiometer 148 provides a base volume level for the musical instrument 100. When the saturation potentiometer 148 is turned all the way down, the musical instrument 100 will produce sound with qualities most like a natural guitar string, whereas when the saturation potentiometer 148 is turned all the way up, the musical instrument 100 will produce a sound at full volume. In this way, the saturation potentiometer 148 receives an input signal from a power source (e.g., an onboard battery or power cable connected to an external power source) and then outputs a baseline electrical signal to the pitch modifier 106. The depicted synthesizer interface 108 also includes guitar-style five-way selector switches 150 (i.e., wave-shapers) to blend the wave shape from the pitch modifier 106, for example, between square and triangle.

Turning to the embodiment of FIG. 16, the synthesizer interface 108 includes a VCA module 152 having ATTACK, SUSTAIN, and RELEASE control features and a KBD module 154 with GLISS button and QUANT control features. The digital synthesizer interface 108 includes additional control buttons 156 for operating WAVE, OPEN, VOICE, OCTAVE, and MEM functions. An LFO module 158 is also included in the depicted synthesizer interface 108 to control RATE, DEPTH, SHAPE, and DELAY features. Using the VCA module 152, KBD module 154, control buttons 156, and LFO module 158, the user can perform numerous modifications to the synthesized signal.

It will be appreciated that, in some embodiments, each magnetic resonance actuator 112 is mated with one horizontal line of controls on the synthesizer interface 108. For example, the embodiment of FIGS. 1A and 2A depict embodiments of the synthesizer interface 108 with controls that correspond to each magnetic resonance actuator 112.

For the final sound, the musical instrument 100 may include an output 160 (e.g., a ¼″ mono phone jack output) for connecting the instrument to an external amplifier, headphones, recording equipment or other sound-processing equipment. In other embodiments, the musical instrument 100 includes an integrated speaker for projecting the synthesized sound.

The musical instrument 100 may also include an LED power indicator and a battery source 162 (e.g., a 6 v battery source (4×AA batteries), preferably consuming less than 50 mA of power). In exemplary embodiments, a single battery 162 provides current to the pitch modifier 106 and the voltage generator 104. Each electric component within the musical instrument 100 can be connected to a common ground. Alternatively, the musical instrument 100 may be powered via a USB port 164 or by other cable to an external power source.

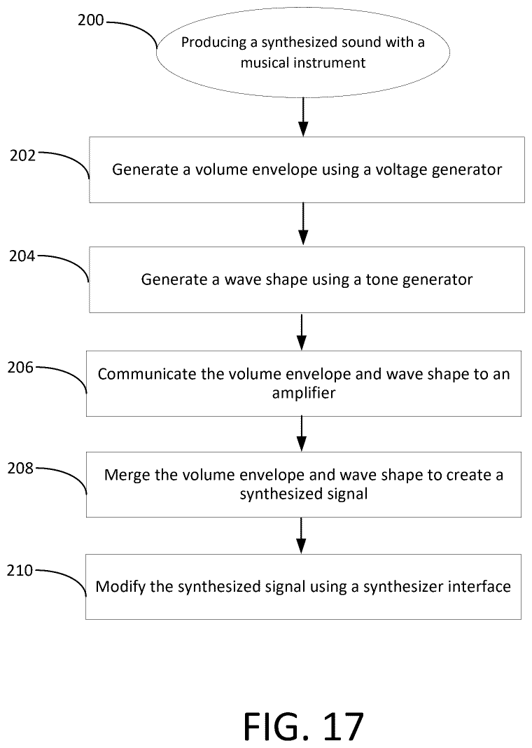

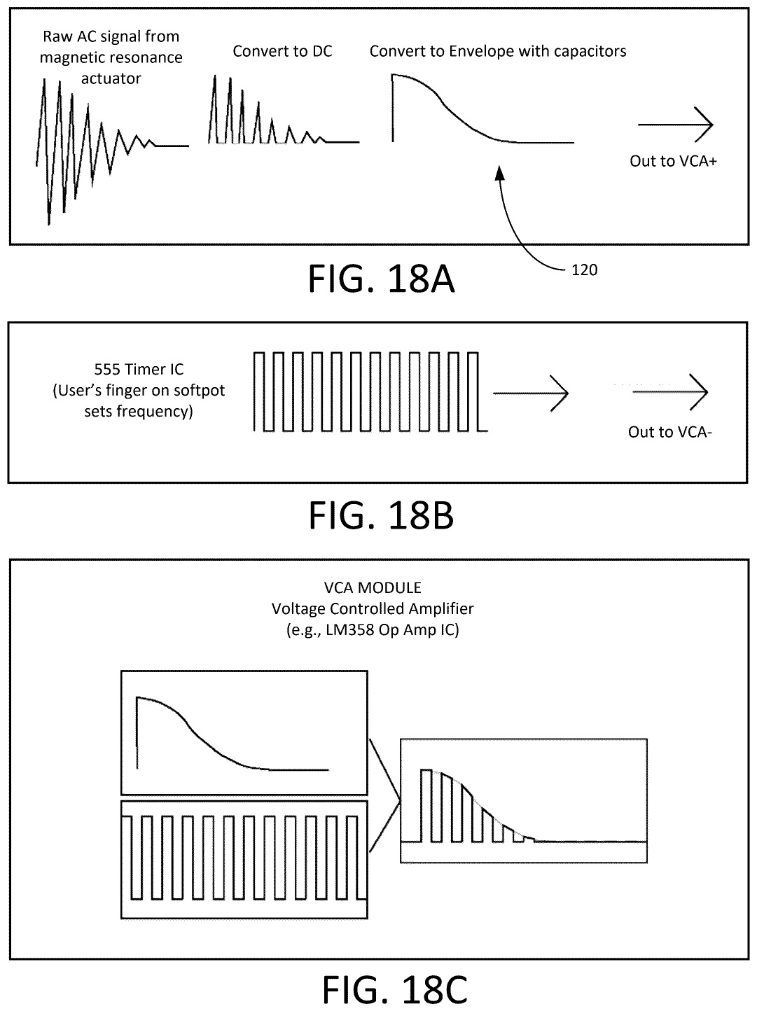

As shown in FIG. 17, a method 200 for producing a synthesized sound with a musical instrument involves a step 202 of generating a volume envelope using a voltage generator. Step 202 may be performed by perturbing a magnetic resonance actuator that is positioned above and parallel to an electronic pickup. In various embodiments, the magnetic resonance actuator may be perturbed using the user's fingers, a guitar pick, or a violin bow. As the magnetic resonance actuator vibrates, the corresponding electronic pickup transforms the mechanical energy into electrical energy as its magnetic field moves. A series of analog components are then used to create the volume envelope. As shown in FIG. 18A, one or more capacitors are used to convert the raw AC signal from the magnetic resonance actuator into a DC signal that will be communicated to the amplifier (VCA+).

Turning to step 204, a wave shape is also generated using a pitch modifier. Generation of the wave shape from the pitch modifier may be initiated by contacting a membrane potentiometer or by setting a tuner knob to a desired frequency. The pitch modifier uses an audio oscillator to generate a waveshape that will be communicated to the amplifier (VCA−), as shown in FIG. 18B.

In other words, the voltage generator and the pitch modifier each produce independent electrical signals that represent, respectively, the volume envelope and the waveshape. It will be appreciated that steps 202 and 204 occur simultaneously in various embodiments. At step 206, the mechanically produced volume envelope from the voltage generator and the wave shape provided from the pitch modifier are communicated to the amplifier 132, which merges the volume envelope and wave shape at step 208 to create a synthesized signal. The merging of the volume envelope and the wave shape is graphically depicted at FIG. 18C.

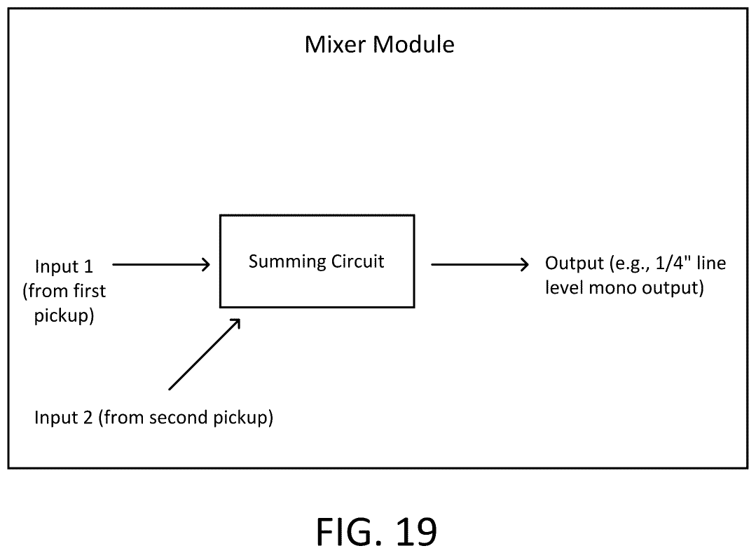

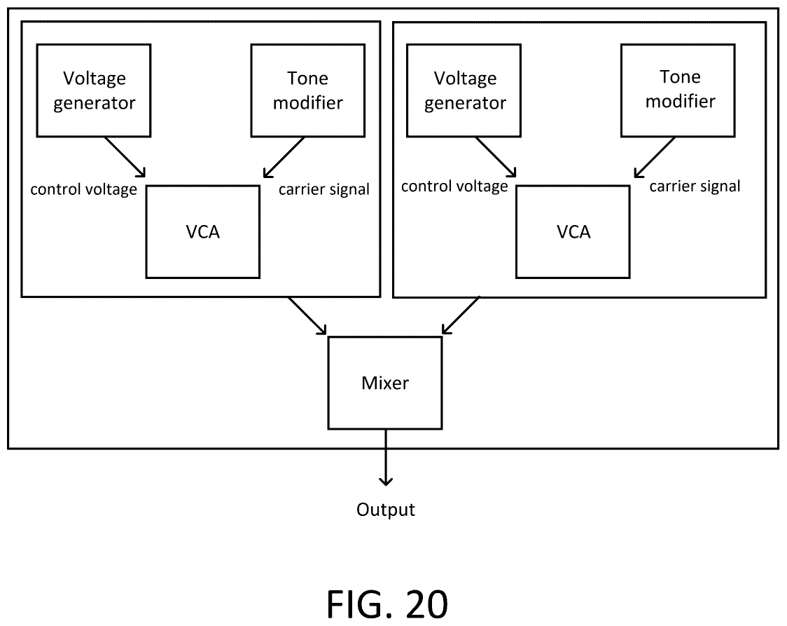

In some embodiments, each electronic pickup on the musical instrument relates to a separate synthesized signal. As a polyphonic instrument, where more than one magnetic resonance actuator is perturbed, the musical instrument can route a corresponding number of synthesized signals to a mixer module (summing circuit), as shown in FIGS. 19 and 20. This combination of multiple synthesized signals (e.g., Input 1, Input 2) produces a final synthesized sound that is communicated to the instrument's output.

It will be appreciated that, in other embodiments, the musical instrument 100 produces a synthesized sound using input from the pitch modifier alone (i.e., without use of the voltage generator). In one embodiment, a saturation knob is turned up to produce a sound whenever the user contacts the pitch modifier. In other words, a signal is generated at full volume, while the user's interaction with the pitch modifier sets the pitch of that signal.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed herein.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms such as “connected,” “connecting,” “attached,” “attaching,” “join,” and “joining” are used interchangeably and refer to one structure or surface being secured to another structure or surface or integrally fabricated in one piece.

For purposes of the disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

Although an overview of the disclosed subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It is claimed:

1. A musical instrument comprising:
a voltage generator configured to generate a volume envelope, the voltage generator comprising:
an electronic pickup, and
a magnetic resonance actuator positioned above and oriented parallel to the electronic pickup; and
a synthesizer interface that is configured to modify a synthesized signal derived from the volume envelope.

2. The musical instrument of claim 1, wherein the voltage generator is configured to generate the volume envelope by vibrating a magnetic field of the electronic pickup using the magnetic resonance actuator.

3. The musical instrument of claim 1, wherein the voltage generator further comprises an actuator mount that is configured to hold the magnetic resonance actuator at a user-selected height above the electronic pickup.

4. The musical instrument of claim 3, wherein the magnetic resonance actuator is configured for removal from the actuator mount.

5. The musical instrument of claim 4, further comprising a handheld magnetic resonance actuator, wherein the voltage generator is configured to generate the volume envelope by removing the magnetic resonance actuator from the actuator mount and by vibrating a magnetic field of the electronic pickup using the handheld magnetic resonance actuator.

6. The musical instrument of claim 4, further comprising a second magnetic resonance actuator that is configured for receipt into the actuator mount when the magnetic resonance actuator is removed from the actuator mount.

7. The musical instrument of claim 6, wherein the magnetic resonance actuator comprises a spring, and the second magnetic resonance actuator comprises a rod.

8. The musical instrument of claim 6, wherein the magnetic resonance actuator comprises a rod, and the second magnetic resonance actuator comprises a spring.

9. The musical instrument of claim 1, further comprising:
a pitch modifier configured to generate a wave shape; and
an amplifier configured to merge the volume envelope from the voltage generator and the wave shape from the pitch modifier to derive the synthesized signal.

10. The musical instrument of claim 9, wherein the pitch modifier comprises a membrane potentiometer.

11. The musical instrument of claim 9, wherein the synthesizer interface comprises at least one selector switch configured to modify the wave shape from the pitch modifier.

12. A musical instrument comprising:
a voltage generator configured to generate a volume envelope, the voltage generator comprising:
a plurality of electronic pickups, and
a plurality of magnetic resonance actuators, wherein each magnetic resonance actuator is positioned above and oriented parallel to one of the electronic pickups;
a pitch modifier configured to generate a wave shape; and
a synthesizer interface configured to modify a synthesized signal that is derived from the volume envelope and the wave shape.

13. The musical instrument of claim 12, further comprising an amplifier configured to merge the volume envelope from the voltage generator and the wave shape from the pitch modifier to derive the synthesized signal.

14. The musical instrument of claim 12, further comprising an actuator mount configured to hold each of the magnetic resonance actuators at user-selected heights above the electronic pickups.

15. A method for producing a synthesized sound with a musical instrument, the method comprising:
generating a volume envelope with a voltage generator, wherein the voltage generator comprises:
an electronic pickup, and
a magnetic resonance actuator positioned above and oriented parallel to the electronic pickup;
generating a wave shape with a pitch modifier;
merging the volume envelope from the voltage generator and the wave shape from the pitch modifier to create a synthesized signal; and
modifying the synthesized signal using a synthesizer interface.

16. The method of claim 15, further comprising the steps of:
generating a second volume envelope by vibrating a magnetic field of the electronic pickup using the magnetic resonance actuator;
generating a second wave shape using the pitch modifier;
merging the second volume envelope and the second wave shape to create a second synthesized signal; and
modifying the second synthesized signal using the synthesizer interface.

17. The method of claim 16, further comprising the step of mixing the synthesized signal and the second synthesized signal to produce the synthesized sound.

18. The method of claim 15, wherein the voltage generator further comprises a second electronic pickup and a second magnetic resonance actuator positioned above and oriented parallel to the second electronic pickup, the method further comprising the steps of:
generating a second volume envelope by vibrating a magnetic field of the second electronic pickup using the second magnetic resonance actuator;
generating a second wave shape using a pitch modifier;
merging the second volume envelope and the second wave shape to create a second synthesized signal; and
modifying the second synthesized signal using a synthesizer interface.

19. The method of claim 15, further comprising the steps of:
removing the magnetic resonance actuator from its position above and parallel to the electronic pickup; and
inserting a second magnetic resonance actuator into the position above and parallel to the electronic pickup.

20. The method of claim 19, further comprising the steps of:
generating a second volume envelope by vibrating a magnetic field of the electronic pickup using the second magnetic resonance actuator;
generating a second wave shape using a pitch modifier;
merging the second volume envelope and the second wave shape to create a second synthesized signal; and
modifying the second synthesized signal using a synthesizer interface.
